(19) United States
(12) Patent Application Publication
(10) Pub. No.: US 2008/0034105 A1
(43) Pub. Date: Feb. 7, 2008

(54) System and method for delivering contents by exploiting unused capacities in a communication network

(75) Inventors: Wei K. Tsai, Irvine, CA (US); Jordi Ros-Giralt, Aliso Viejo, CA (US)

Correspondence Address: OBLON, SPIVAK, MCCLELLAND MAIER & NEUSTADT, P.C., 1940 DUKE STREET, ALEXANDRIA, VA, 22314, US

(73) Assignee: IST International Inc., Aliso Viejo, CA (US)

(21) Appl. No.: 11/497,298

(22) Filed: Aug. 2, 2006

(51) Int. Cl. H04L 12/26; G06F 15/16; G08C 15/00; G01R 31/08; H04L 1/00; G06F 11/00

(52) U.S. Cl. 709/232; 370/230; 709/231

(57) ABSTRACT

There is provided a method of delivering a plurality of source streams from a plurality of servers to a plurality of clients through a plurality of routers over a communication network using a pay-per-period pricing scheme. Said method includes: splitting the source stream into a plurality of sub-streams to the routers; estimating available capacities of the plurality of the routers; and delivering the sub-streams to the routers at transmission rates proportional to the available capacities of the routers. The available capacity is estimated based on input and output traffic correlations in the server. Further, the client, who is not an owner of the available capacity, may be allowed to use the available capacity at a lower priority than that of the owner. The delivery of the source stream may be carried out over a plurality of paths over the communication network, wherein time-space trajectories of the paths do not cross each other. The method of the present invention provides a large-scale optimal exploitation of available capacities such as network bandwidths and computing resources for content delivery, while ensuring high QoS of content delivery.

### FIELD OF THE INVENTION

The present invention generally relates to a system and method for delivering contents by exploiting unused capacities such as bandwidths and computing resources, and more particularly to a system and method for delivering contents over a communication network by exploiting bandwidths and computing resources, which are unused by the original owners in pay-per-period pricing schemes.

### BACKGROUND OF THE INVENTION

Resource sharing is fundamental in modem networking technologies, which are adapted to deliver contents over a communication network. Shared resources can be broadly classified into computing and communication capacities. Various methods have been used to exploit shared resources, including statistical multiplexing, peer-to-peer sharing, fair queuing, differentiated service, bandwidth reservations, etc.

Conventionally, shared resources reside in the public domain such as the Internet and telecom carrier networks. Increasingly, however, shared resources have been shifting to end users, as evidenced by the introduction of P2P (peer-to-peer) sharing technology. In the P2P sharing technology, the end user becomes both the client and the server, and is thus referred to as a peer. This is distinguished from the conventional server-client model, wherein the server provides a service to the client permitted to access the server.

The P2P sharing technology has been conceived based on its recognition of unused capacities, which are ubiquitous over worldwide networks, especially computing resources and bandwidths at the end user's side. Generally, in life, there is inevitably an oversupply of goods and services, large portions of which are left unused. Since the demand for goods and services is uncertain and can be even unexpected, the provisioning of goods and services must exceed the average demand in order to satisfy the ever changing and sudden demands. Recently, bandwidths of networks are abundantly supplied. Likewise, computing resources are similarly oversupplied over the networks to a lesser extent. Such oversupply of network bandwidths and computing resources often leads to a Peak-to-Sustained (P2S) ratio, which is significantly greater than one.

Many IT-related businesses are built to maintain large P2S ratios. For example, most corporations maintain a website that can serve a peak traffic rate, while the average traffic rate is often 2 to 3 times smaller than the peak traffic rate. Further, in order to guarantee QoS against sudden loss of capacity, standby bandwidths and servers are often employed; these communication and computing resources are designed to remain unused under normal circumstances. The above situations can be analogized to that of the end user. A residential broadband provider must provide bandwidths to satisfy the peak traffic rate such that even if numerous household members access the web at the same time, the speed of downloading contents can be within a satisfactory level. In another example, a typical PC user will require a high CPU speed simply to satisfy his/her spontaneous computing needs while his PC sits idling during most of its life time.

Due to above mentioned anomaly, it is possible to build IT businesses to profit from large P2S ratios. For example, a wholesaler of bandwidths usually purchases a large chunk of bandwidths from a telecom carrier and sells bandwidths, which are divided in smaller chunks, to various subscribers. Since the subscribers will not use the bandwidths all at the same time, the wholesaler typically oversubscribes the bandwidth usage and makes a significant profit by charging the peak usage instead of the actual usage.

In order to exploit the unused bandwidths in the household broadband access market, many broadband providers (e.g., Mushroom Networks and WiBoost Networks) provide a technology allowing a user to tap unused bandwidths owned by other users. Such a technology is based on the conventional idea of statistical multiplexing. However, this technology exploits only local (neighboring) unused bandwidths. Therefore, there is a need for technology that can systematically exploit large aggregates of (both corporate and household) unused capacities in real time.

An important problem in utilizing unused bandwidths (also known as “available bandwidths” in the networking industry) is to estimate the amount of available bandwidths for further use. There are currently several methods for estimating the available bandwidths for both general communication and bottleneck links. These methods measure the unused bandwidths by sending probe packets and performing further computations based on a mathematical theory of traffic to obtain final estimates. However, such methods fail to take into account all information available for estimation.

Further, fast delivery of rich-media contents (e.g., video, high-quality audio, graphic-intensive web browsing, etc.) typically requires large amounts bandwidths and computing resources. In real network environments, due to the lack of sufficient capacities (hereinafter, the term “capacity” is used to described bandwidth, computing capacity, or both), rich-media content streaming is performed with two compromises. The first compromise is made in the time dimension, wherein rich-media contents are delivered over a longer period of time with limited bandwidths. As such, a viewer of the contents adopts a store-and-view strategy. Also, the download of the contents is scheduled to begin at a certain time before the actual viewing, which results in delays in the viewing of the rich-media contents. In the second compromise, the viewer simply switches to lower-quality contents if the timeliness of viewing is important. All of the above compromises lead to a lower QoS (Quality of Service) of content delivery.

To solve the QoS problem of content delivery, it is highly beneficial to maximize sharing and to exploit unused capacities whenever possible. Many service providers such as CDN (Content Distribution Network) employ various methods of resource sharing within their networks and the public networks, where servers are often distributed across the networks to serve the clients located near the servers. However, the exploitation of unused capacities is performed only within their own network infrastructures. Thus, such an approach is often costly since a massive build-up for the infrastructures is required.

Another problem in delivering rich-media contents is that a peak packet loss rate in networks could become too large (an average packet loss rate is often too small to be of significance). A typical method for reducing the peak packet loss rate is to split a source stream into multiple sub-streams (referred to as “striping”) and to send the multiple sub-streams through independent paths over networks. However, the main obstacle in providing multi-paths with striping is that finding truly independent paths over networks is typically very difficult.

### SUMMARY OF THE INVENTION

It is, therefore, an object of the present invention to provide a system and method that can optimally exploit and share available capacities such as network bandwidths and computing resources for content delivery at a large-scale level.

It is another object of the present invention to provide a system and method for estimating the amount of present and future available capacity (bandwidth, computing capacity, or both) for a device connecting to a communication network.

It is another object of the present invention to provide a system and method for estimating the amount of present and future available bandwidths for links connecting a plurality of servers to a communication network.

It is another object of the present invention to provide a system and method for estimating the amount of present and future available computing capacity for a plurality servers connecting to a communication network.

It is yet another object of the present invention to provide a system and method for guaranteeing a high QoS of content delivery while reducing the costs of build-up and maintenance for content delivery systems.

In accordance with one aspect of the present invention, there is provided a method for exploiting available capacity in a content delivery system, which delivers a source stream from a group of servers to a client (unicast or a group of unicasts) over a communication network using pay-per-period pricing scheme. Such a method includes estimating the present and future available capacities and delivering the source stream through paths over the communication network, which are determined based on the estimated available capacities.

In accordance with another aspect of the present invention, there is provided a method for delivering a source stream from a server to a plurality of clients (simple multicasts) through numerous routers over a communication network using pay-per-period pricing scheme. Such a method includes: splitting the source stream into a plurality of sub-streams to a plurality of multicast-capable routers; estimating the present and future available capacities of the routers; and delivering the sub-streams to the routers at transmission rates proportional to the available capacities of the routers, which might be varying in time.

In accordance with yet another aspect of the present invention, a client who is not an owner of the available capacities may be allowed to use the available capacities at a priority lower than that of the owner. Therefore, delivering the source stream may be interrupted by the owner requesting the use of the available capacity.

Preferably, delivering the source stream may be carried out over a plurality of paths over the communication network, wherein time-space trajectories of the paths do not cross each other.

In accordance with yet another aspect of the present invention, there is provided a content delivery system for delivering a plurality of source streams to a plurality of clients (many-to-many multicasts) over a communication network using pay-per-period pricing scheme. Such a system includes: a plurality of servers splitting the source streams into a plurality of sub-streams; a plurality of multicast-capable routers receiving the plurality of sub-streams and sending the received sub-streams; and a plurality of clients receiving the sub-streams from the routers. Preferably, the rates of transmitting the sub-streams from the server to the routers are proportional to the available bandwidths of the routers, which might be varying in time.

The present and future available bandwidths of the multicast-ready routers are estimated based on input and output traffic correlations in the routers. The multicast-ready router is considered as a server configured to duplicate a stream into a plurality of sub-streams to be sent to the clients and/or unicast routers for further forwarding the sub-streams to the clients. Further, in this system, the sub-streams may be transmitted over a plurality of paths over the communication network, wherein time-space trajectories of the paths do not cross each other.

Preferably, the system may further include a plurality of control devices adapted to perform an admission control to determine whether a connection requested by one of the clients is to be established. The control devices may perform resource allocation based on the available capacities of the system.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows a system identification process for constructing a model to estimate a plurality of servers' bandwidths (both present and future bandwidths) in accordance with one embodiment of the present invention;

FIG. 2 presents a configuration of a typical data center or IT room, which is used as a reference configuration for a system identification process for estimating a plurality of servers' present and future bandwidths in accordance with one embodiment of the present invention;

FIG. 3 sets forth a configuration for a system identification process for estimating bandwidths at a data center or IT room as shown in FIG. 2;

FIG. 4 illustrates a schematic view of a content delivery system, wherein one sub-group of M-boxes exists in accordance with one embodiment of the present invention;

FIG. 5 describes a graph illustrating an optimal assignment of transmission rates from the S-box to the M-boxes in the content delivery system as shown in FIG. 4;

FIG. 6 depicts a schematic view of a content delivery system, wherein multiple S-boxes are connected to numerous sub-groups of M-boxes, in accordance with one embodiment of the present invention;

FIG. 7 presents a timing chart showing how independent paths are determined in space-time continuum in accordance with one embodiment of the present invention;

FIG. 8 shows control flows when the admission control is performed by a C-box in a content delivery system in accordance with one embodiment of the present invention; and

FIG. 9 shows control flows when the admission control is performed by a plurality of C-boxes in a content delivery system in accordance with one embodiment of the present invention.

### DETAILED DESCRIPTION OF THE PRESENT INVENTION

In the present invention, a generic capacity is considered to be associated with a generic server. For example, a bandwidth capacity is associated with a router or server that connect to another device through a network interface. Similar, a computing capacity is associated with a server that is capable of processing data and packets.

The present invention is directed to a system and method for exploiting capacities such as bandwidths and computing resources, which are unused by the original owners, in a content delivery system. The pricing scheme for the capacities is a significant factor for determining whether exploiting the unused capacities is beneficial to the clients. The pricing schemes for clients in a content delivery system can be broadly classified into two types: PPP (pay-per-period) and PPU (pay-per-use). In the PPU pricing scheme, there is no economic value in exploiting the unused capacities since any further use of the capacities will incur a cost. On the other hand, the unused capacities in the PPP pricing scheme represents a ZOC (zero opportunity cost) capacity. That is, the value of such capacities will be lost if they are left unused, while no additional (opportunistic) cost is incurred if they are used (exploited). The present invention exploits ZOC capacities for two possible situations, that is, when the P2S ratio is large and when a large amount of unused capacities exists for a long period of time.

To exploit the unused capacities in a content delivery system, the present invention provides a method of determining a ZOC capacity in real time. In the PPP pricing scheme, if capacities such as bandwidths and computing resources are unused at a time epoch, then the value of the capacities is lost for that time epoch. The current unused capacities are easily determined by subtracting the current usage from given capacities. Herein, unused capacities will be referred to as “available capacities.” Particularly, in one embodiment of the present invention, the traffic on a link, which connects a server to a communication network, is estimated to obtain on-ramp (outbound) ZOC bandwidth on the link for the server. If a link is connected to a group of servers that serve the contents for clients, then the outbound ZOC bandwidth of the servers on the link can be estimated by using a mathematical input-output model, which correlates the input traffic to the servers with the output traffic from the servers.

In networks today, aggregate traffic follows definite cyclical patterns (in time frames of minutes, hours, days, months and years) that are often exploited by network operators. These patterns are easily discerned by the input-output system identification techniques that correlate input traffic to output traffic of a network system. Further, once the patterns are discerned, they can be used to predict future available ZOC capacities.

In a content delivery system of the present invention, the ZOC capacity can be exploited according to two locality principles: locality in time and locality in space. Due to human behavior, a physical device in a content delivery system may be left unused when a user is in recess. Such a behavior creates tremendous amounts of ZOC capacities. For example, network bandwidths in the content delivery system may be used very often during work hours, while being practically unused during non-work hours. The usage of capacities in a content delivery system may form a cyclical pattern that, for example, repeats daily, weekly or seasonally. Further, the global time zones create a space locality of capacities in content delivery systems. For example, while people in Asia are asleep, people in the U.S. may be actively working, and vice-versa.

The fact that the human use of bandwidths and computing resources exhibits cyclical patterns strongly suggests that mathematical models can be employed to predict the future use of these resources. In one embodiment of the present invention, input/output mathematical models are employed to produce predictions of the form: (capacity, begin time, end time, probability), wherein the number capacity represents the ZOC capacity of the underlying resource, the number begin time is the starting time of the ZOC capacity, the number end time is the ending time of the ZOC capacity, and finally, the number probability is the numerical probability that the stated ZOC capacity in time is actually available. These predictions are used as the basis for reserving high probability and medium probability ZOC capacities in the admission control.

Further, in one embodiment of the present invention, the ZOC capacity is utilized in the content delivery system in such a manner as to ensure that the work of the original owner is not interfered by stopping any further use of the ZOC capacity by the non-owners when the original owner wants to use the capacity. Particularly, the non-owners' use of the ZOC capacity is considered to be of the lowest priority and is implemented as such. That is, the non-owner is allowed to use the capacity at a lower priority than that of the original owner.

In the following sections, preferred embodiments of the present invention will be described in detail with reference to the drawings.

As discussed above, in accordance with the present invention, the present and future traffic on a link, which connects a server to a communication network, is estimated to obtain the present and future on-ramp ZOC bandwidth for the server. For example, in a data center or corporate IT room, the output traffic from the server is highly correlated to the inbound (off-ramp) traffic to the server. In such a case, the outbound traffic of the server can be estimated by using a mathematical input-output model, which correlates the input traffic to the server with the output traffic of the server. Further, this input-output model can be calculated by employing one of the well-known system identification processes (e.g., process based on pattern recognition or artificial neural networks). In a similar manner, the present and future off-ramp ZOC bandwidths to a plurality of servers can be estimated

In accordance with the present invention, the present and future ZOC bandwidth on any communication link, which carries the traffic from a network device to another, is estimated based on the input-output mathematical model correlating the traffic on the link to the traffic in and out of the device other than except the traffic on the link.

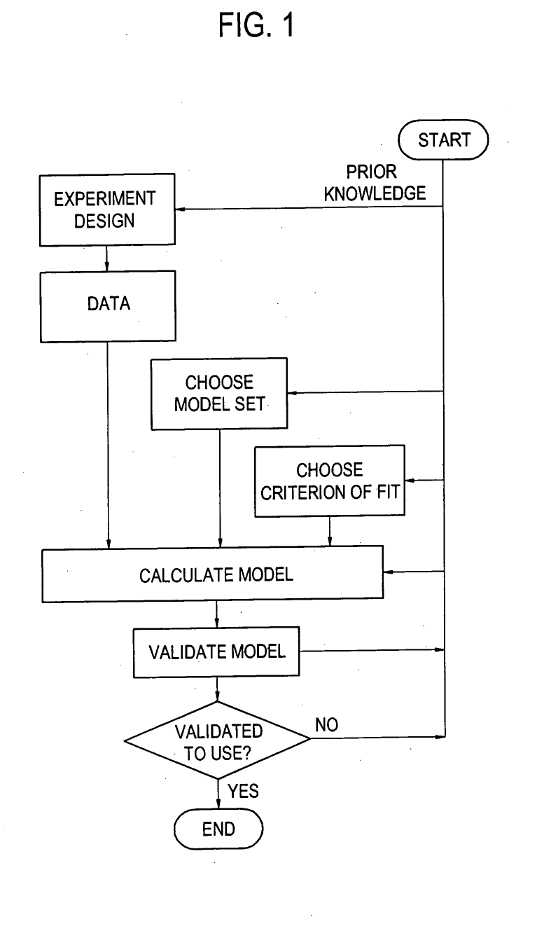

In one embodiment of the present invention, a system identification process, which is shown in FIG. 1, may be used to construct a model for estimating a server output bandwidth for the present and future. In this process, as shown in FIG. 1, a-priori knowledge regarding a target system (i.e., a server) is applied in order to design an experiment, wherein input/output data for the target system are collected. Then, a most suitable model is selected within a set of models based on the input/output data and a given criterion of fit. The selected model is validated to determine whether it satisfies a predetermined requirement. If the selected model does not satisfy the requirement, then the above process is repeated until a model satisfying the requirement is found.

The method for estimating the present and future ZOC bandwidth on an on-ramp link connecting a server to the network using a mathematical input-output model is distinguished from the conventional methods for estimating available bandwidth on the link, which send probe packets to a link and measure a response end-to-end. The conventional methods are known to be unreliable since they theoretically measure only the bottleneck bandwidths, and are useful only for estimating current bandwidth usage. Therefore, when and if a particular on-ramp link is not a bottleneck, the measurement will suffer from poor accuracy. On the contrary, the method employed by the present invention avoids directly measuring the bandwidth at a link. Rather, it estimates the bandwidth at the source of traffic, i.e., the server with the on-ramp link. This approach has several advantages as follows. That is, the estimation of the server output traffic is far more accurate and the input-output model is capable of predicting the future output traffic if the future input traffic is known. And due to the cyclical nature of the Internet traffic, the future input traffic can be fairly accurately predicted; making this process capable of predicting also the future server output traffic. Further, there is no need for the on-ramp link at the server to be a bottleneck at all.

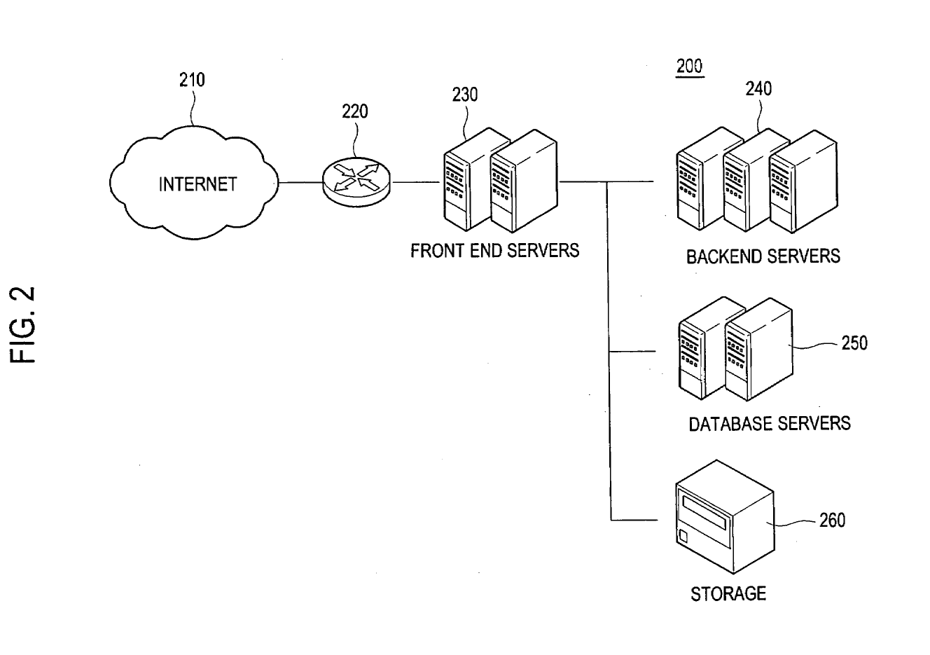

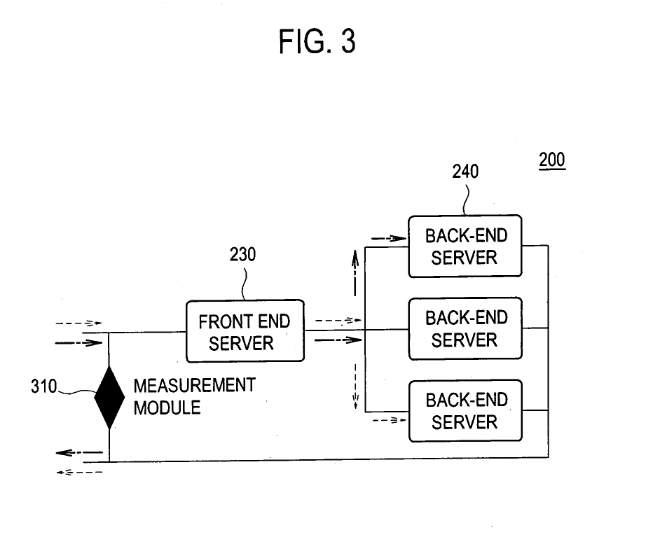

FIG. 2 presents a configuration of a typical data center or IT room 200. This configuration may be used as a reference configuration for a system identification process for estimating a server output bandwidth, wherein a group of servers including front end servers 230, back end servers 240, database servers 250, and storage 260, are connected to the Internet 210 through a router 220. FIG. 3 shows a configuration for a system identification process for estimating an on-ramp bandwidth at a data center or IT room 200, as shown in FIG. 2. In the configuration shown in FIG. 3, a system to be identified is total output bandwidth (for both the present and the future) from a group of servers including the front end servers 230 and the back end servers 240. A measurement module 310 uses input traffic streams to the front end servers 230 as input signals to the system. It further uses output bandwidths from both the front end servers 230 and back end servers 240 (which might include database servers and storage devices) as output signals from the system. By subtracting the total output bandwidths out of the servers from the given on-ramp bandwidth, the total present and future available on-ramp bandwidth for the servers is estimated.

The above-described method for estimating available bandwidths in a server may be applied to a content delivery system for providing a streaming service from a single source to a large number of clients. In one embodiment of the present invention, a content delivery system includes a single source box (“S-box”), a plurality of control boxes (“C-boxes”), a plurality of multicast routers (“M-boxes”), and a plurality of target boxes (“T-boxes”), all of which are logical devices. That is, a logical device is one that implements a logical function while no further implementation detail is specified.

The S-box represents a device containing an original source stream, which splits the source stream into multiple sub-streams transmitted to the M-boxes. The M-box refers to a device with a multicast capability and a positive ZOC bandwidth. All these devices are located at the edge of a communication network and have a connection to the network.

In the case of multicast delivery, the M-boxes may be organized into one or more sub-groups of M-boxes. If there is a sub-group of n M-boxes, then the S-box divides the original source stream into n sub-streams, each of which may have a different transmission rate. It then forwards them to the respective M-boxes in the sub-group. Each sub-group of M-boxes is associated with a corresponding sub-group of T-boxes. In this corresponding sub-group of T-boxes, each T-box receives a sub-stream from each M-box in the corresponding sub-group of M-boxes. Therefore, the function of an M-box is to duplicate the sub-stream sent from the S-box and to forward the duplicated sub-stream to a T-box in the corresponding sub-group. Further, the number of T-boxes may vary depending on the capacities of the M-boxes.

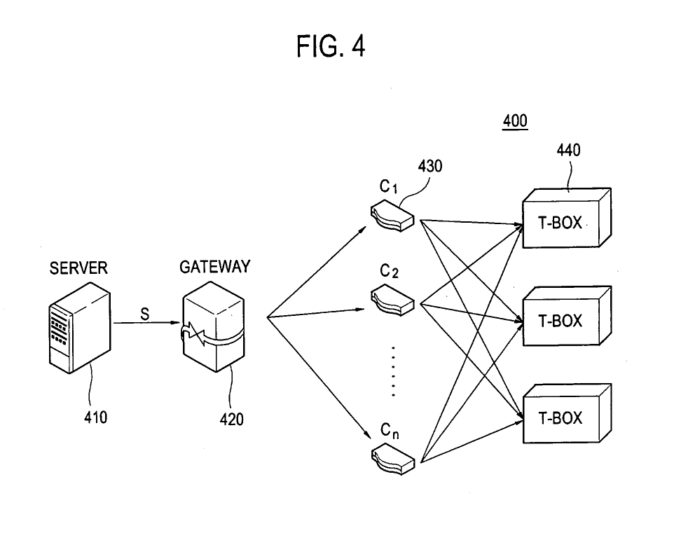

FIG. 4 shows a schematic view of a multicast content delivery system, wherein only one sub-group of M-boxes is provided, in accordance with one embodiment of the present invention. In FIG. 4, a gateway 420 represents an entry point of a server (S-box) 410 to the Internet. S-box 410 sends n different sub-streams, which together constitute a complete stream of transmission rate s. Further, each of n multicast routers (M-boxes) 430 has the same number of duplicate sub-streams to be sent to the client systems (T-boxes) 440. In case of multicast streaming, each of M-boxes 430 duplicates the packets. On the other hand, in case of unicast streaming, each of M-boxes 430 does not duplicate the packets, and rather acts as a relay.

In accordance with one embodiment of the present invention, the content delivery system 400, which is shown in FIG. 4, splits the sub-streams from S-box 410 to M-boxes 430 as follows. Given a set of n M-boxes 430 each with a known ZOC bandwidth and assuming that each of T-boxes 440 must receive a sub-stream from each of M-boxes 430, the rates of the sub-streams sent from S-box 410 to M-boxes 430 are determined to be directly proportional to the capacity of corresponding M-boxes 430. In this way, the number of clients (i.e., T-boxes 440) served can be maximized.

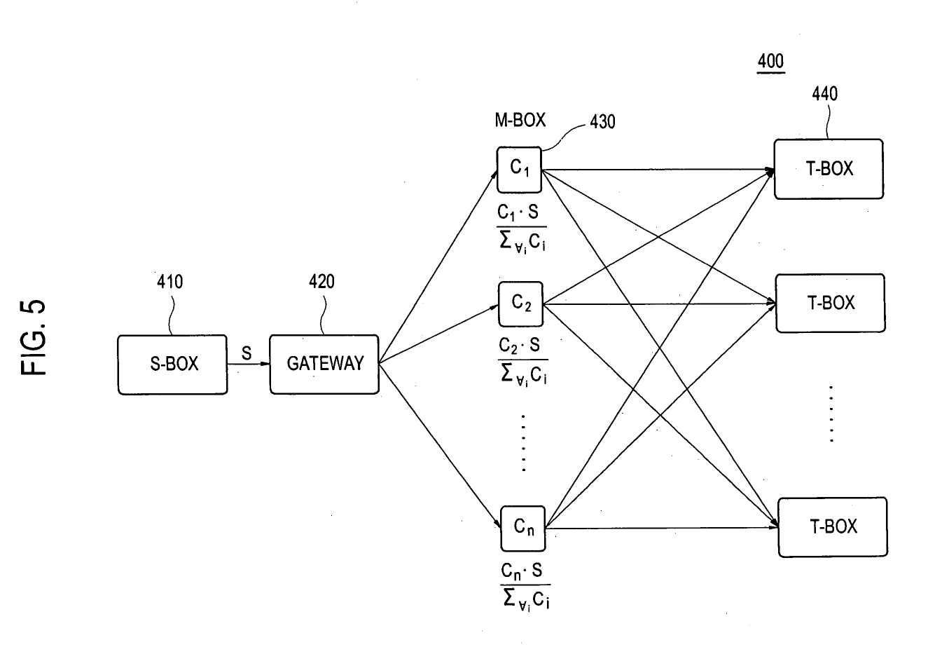

FIG. 5 sets forth a diagram illustrating the optimal assignment of transmission rates from S-box 410 to the multicast routers (i.e., M-boxes 430) in the multicast content delivery system 400 shown in FIG. 4. In FIG. 5, each of M-boxes 430 sends to the entire set of clients, i.e., T-boxes 440. Further, the numbers on the links from S-box 410 to M-boxes 430 represent the optimal individual rates from the single source S-box 410 with a total rate of s. As shown in such figure, when M-boxes 430 have the available capacities. Cₗ through Cₙ, the number of T-boxes 440 served can be maximized when S-box 410 splits the single source into n sub-streams with a rate of

$$\frac{{c}_{i} \cdot s}{{\sum }_{{∀}_{i}} {c}_{i}} ,$$

wherein i indicates i-th M-box.

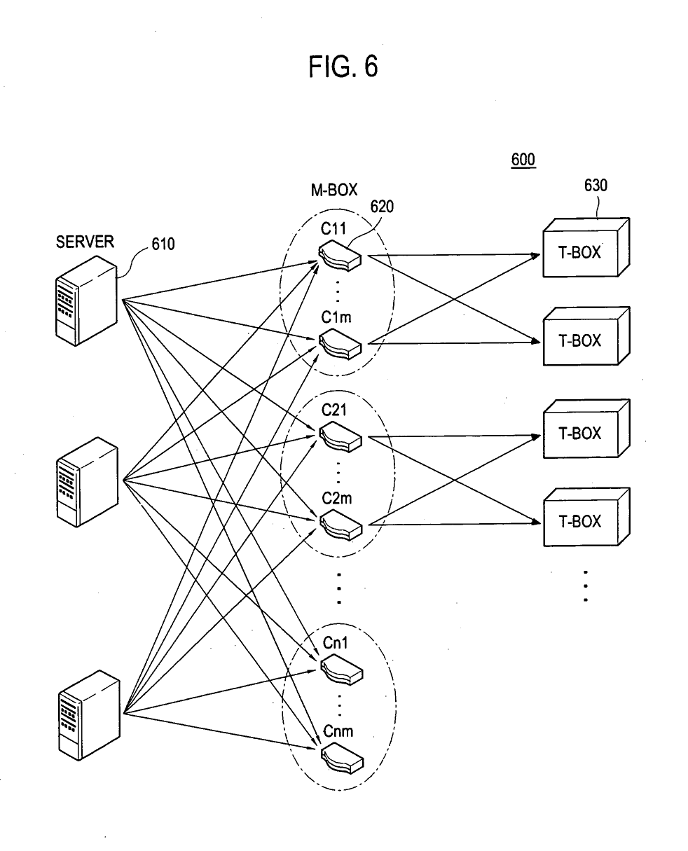

FIG. 6 describes a schematic view of a many-to-many multicast content delivery system, wherein multiple S-boxes 610 are connected to a plurality of sub-groups of M-boxes 620, in accordance with one embodiment of the present invention. In this embodiment, multiple S-boxes 610 may or may not represent the same streaming source. If multiple S-boxes 610 represent the same streaming source, then this means that a single streaming source is split into a plurality of streaming sources, each of which is sent to the same router (i.e., one of M-boxes 620). In such configuration, there is little differentiation between a server and M-box. If any one of the S-boxes/M-boxes fails, then only a fraction of the total amount of down-stream sent to M-boxes or T-boxes would be lost.

As mentioned above, when delivering a rich-media content such as a video and high-quality audio, it is important to reduce the peak packet loss rate to ensure a high QoS of content delivery. In the content delivery system in accordance with one embodiment of the present invention, multiple sub-streams from a streaming source (i.e., an S-box) are preferably sent to the clients (i.e., T-boxes) over multiple independent paths in order to reduce the peak packet loss rate.

As known to the one skilled in the art, two paths in a content delivery system are considered to be “independent” if they do not share any links. The present invention uses a known method of determining the physical paths of a given connection and schedules the transmission of multiple streams so that the paths can be independent (as much as possible) in the space-time continuum. In the present invention, two paths are considered to be “independent” in the space-time continuum if they do not cross each other in the space-time trajectories of the streams. Independence can be partial in the sense that two paths have respective sub-paths that are independent. In the content delivery system 400 shown in FIG. 4, M-boxes 430 represent “independent” (as much as possible) path entry points for a single stream from S-box 410. To minimize the peak packet loss rate, it is preferable to send a single stream over “independent” paths passing through M-boxes 430. The method of determining “independent” paths in accordance with the present invention can be applied to both multicast and unicast streaming systems. The only difference between the multicast and unicast streaming systems is that in case of unicast streaming, M-boxes do not duplicate the sub-streams but rather simply forward them.

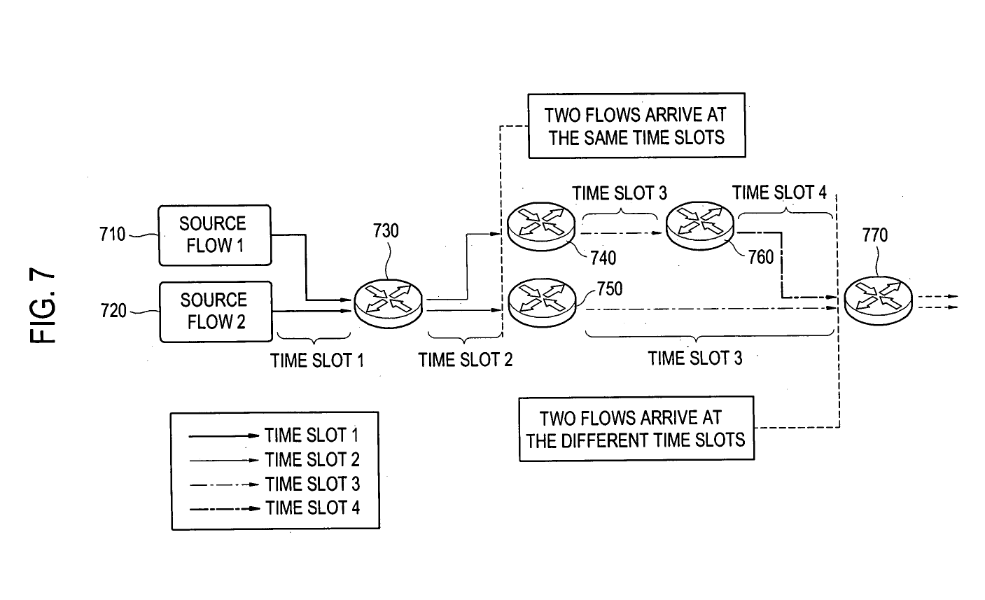

FIG. 7 presents a timing chart showing how independent paths can be determined in the space-time continuum in accordance with one embodiment of the present invention. In FIG. 7, streaming flows (i.e., paths) at different time slots (or time epochs) are coded with different types of lines. Further, a path is defined to start at a specific router (or network node) and end at another specific router (or network node) over specific consecutive time slots, which can be further sub-divided into different sub-paths in the space-time continuum. Two sub-paths, as shown in FIG. 7, are considered to be independent since they start at streaming sources 740 and 750 at the same time slot and arrive at the same router 770 at different time slots 3 and 4 in the space-time continuum.

Further, the present invention provides a method of admission and resource allocation control for a content delivery system. To obtain QoS that is as high as that in a circuit switching network, it is necessary to limit the users admitted to the content delivery system. In one embodiment of the present invention, a method of admission control is exercised by a group of C-boxes (control boxes), which resides on a logical control plane. C-boxes gather the ZOC capacities (network bandwidths and computing resources) associated with servers distributed across a communication network in the content delivery system and compute the effective capacity profile of the content delivery system in terms of a given set of parameters. If a client's request for content delivery arrives at the gate of the content delivery system, then C-boxes determine whether or not to admit a connection between the client and the servers. Further, C-boxes perform a resource allocation control to determine which resource of the servers will be used and which set of M-boxes will be used to deliver the streams through the admitted connection. In the present invention, the admission control may be based on statistical methods of estimating time-dependent availability and capacity profiles similar to that of PSTN (Public Switch Telephone Network).

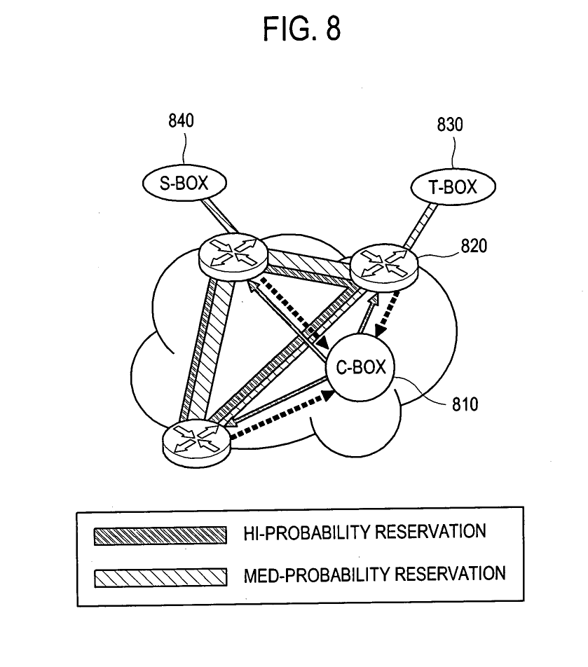

FIG. 8 shows control flows when the admission control is performed in the content delivery system in accordance with one embodiment of the present invention. As shown in FIG. 8, C-boxes 810 may perform a mathematical estimation algorithm to determine the present and future available bandwidths over a communication network with defined time durations, and probabilities, in accordance with the present invention. The high probability and/or medium probability bandwidths are then assigned to S-boxes 840 (i.e., providers of contents) and T-boxes 830 requesting a connection to S-boxes 840 (receivers of contents). If there are not enough bandwidths, then the request of T-boxes 830 is rejected.

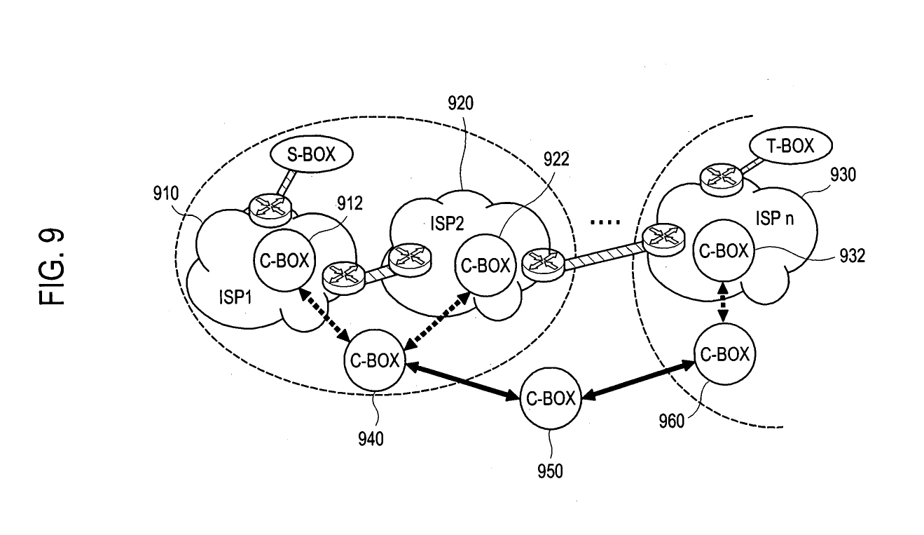

FIG. 9 shows control flows when the admission control is performed in the content delivery system in accordance with another embodiment of the present invention. In this embodiment, C-boxes are organized into a hierarchical structure, wherein C-boxes 912, 922 and 932 are dedicated to local ISPs 910, 920 and 930, respectively. Further, in this embodiment, global C-boxes 940, 950 and 960 are dedicated to performing inter-ISP bandwidth estimation and admission control.

The content delivery system of the present invention ensures that the work of the original owner is not interfered by stopping any further use of the ZOC capacity by non-owners when the original owner wants to use the capacity. Particularly, the non-owner is allowed to use the ZOC capacity only at a lower priority than that of the original owner. Generally, the operating system of a computing element in the content delivery system provides a simple scheme to prioritize the tasks entered by the users. Therefore, the use of ZOC computing capacities by non-owners can be easily accomplished. For a non-owner to use the ZOC bandwidths, the following embodiment can exemplarily illustrate the related set-up. In this embodiment, it is assumed that the available (ZOC) bandwidth connects a group of devices with the right to use the bandwidth to connect to the Internet through a router. A device without any ownership of the bandwidth is connected to the router through a specific port, which is not shared with any owner device traffic. The router is configured to allow the non-owner traffic to enter the router through a port-based priority system. Specifically, a non-owner port has a lower priority than a port with owner traffic.

While the present invention and its various functional components have been described in particular embodiments, it should be appreciated that the present invention can be implemented in hardware, software, firmware, middleware or a combination thereof and utilized in systems, subsystems, components or sub-components thereof. When implemented in software, the elements of the present invention are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g., a processor, a computer, etc.).

Further, while the present invention has been shown and described with respect to a preferred embodiment, those skilled in the art will recognize that various changes and modifications may be made without departing from the spirit and scope of the invention as defined in the appended claims.

What is claimed is:

1. A method for minimizing a peak loss rate in streaming from a source to a client via independent paths and sub-paths in a communication network, wherein the independent paths and sub-paths do not cross each other in the space-time trajectories of the paths and sub-paths.

2. A method of estimating unused capacities of a device connecting to a communication network, based on mathematical correlations between input and output signals from the device that serves the capacities.

3. The method of claim 2, wherein the unused capacities include at least one of a communication bandwidth, data processing capacity, and a data networking capacity.

4. The method of claim 2, wherein the device includes at least one of a communication link, a computer server, and any device that is configured to provide the capacities.

5. A method for exploiting unused services in a service provider system configured to deliver a plurality of services to a plurality of clients, comprising:
estimating present and future unused services; and
delivering the estimated unused services to a plurality of clients without breaching any guarantees made to any one of the clients who pay for the guaranteed services.

6. The method of claim 5, wherein use of the unused guaranteed services by any one of the clients, who is not given any guarantees for the services, does not incur additional costs to any one of the clients who pay for the guaranteed services.

7. The method of claim 5, wherein each of the unused services is represented in a form including begin time, end time, probability of the existence of the service capacity, and an amount of the service capacity in an appropriate unit.

8. A method for exploiting unused capacities in a content delivery system configured to deliver a plurality of source streams from a plurality of servers to a plurality of clients over a communication network, comprising:
estimating present and future unused capacities; and
delivering the source streams through paths over the communication network, wherein the paths are determined based on the estimated unused capacities.

9. The method of claim 8, wherein the unused capacities include at least one of a communication bandwidth, a data processing capacity, and a data networking capacity.

10. The method of claim 8, wherein each of the unused capacities is represented in a form including begin time, end time, probability of the existence of the capacity, and an amount of the capacity in an appropriate unit.

11. The method of claim 8, further comprising:
if any one of the unused capacities is initiated by a non-owner of the unused capacity and an owner of the unused capacity requests use of the capacity at the same time, stopping the use of the capacity by the non-owner, wherein the owner of the capacity is one that pays for use of the capacity.

12. The method of claim 8, further comprising:
splitting each of the source streams in the servers into a plurality of sub-streams to be sent to the plurality of clients via a plurality of routers,
wherein delivering the source streams includes:
delivering the sub-streams from the servers to the routers at transmission rates proportional to respective unused capacities of the routers.

13. The method of claim 12, wherein the transmission rates of the sub-streams are determined to be
$$\frac{{c}_{i} \cdot s}{{\sum }_{{∀}_{i}} {c}_{i}} ,$$
wherein s indicates the rate of the source stream and Ci is the unused bandwidth from an i-th router to the clients, for the source stream.

14. The method of claim 12, further comprising:
duplicating the sub-streams in the routers to be sent to the clients.

15. The method of claim 12, further comprising:
forwarding the sub-streams in the routers to the clients.

16. The method of claim 12, wherein delivering the sub-streams to the routers is performed over independent paths in the communication network, wherein the paths or sub-paths do not cross each other in the space-time trajectories of the paths or sub-paths.

17. The method of claim 8, further comprising performing an admission control to determine whether a connection requested by one of the clients is established.

18. The method of claim 17, further comprising performing a resource allocation based on the unused capacities.

19. A computer-readable medium with a computer program for performing the method as described in any one of claims 1 to 18.

20. A content delivery system for delivering a plurality of source streams over a communication network, comprising:
a plurality of servers providing a plurality of source streams; and
a plurality of clients receiving the source streams from the plurality of servers,
wherein the system estimates present and future unused capacities and delivers the source streams through paths over the communication network, the paths being determined based on the estimated unused capacities.

21. The system of claim 20, wherein the unused capacities include at least one of a communication bandwidth, a data processing capacity, and a data networking capacity.

22. The system of claim 20, wherein each of the unused capacities is represented in a form including begin time, end time, probability of the existence of the capacity, and an amount of the capacity in an appropriate unit.

23. The system of claim 20, wherein if any one of the unused capacities is initiated by a non-owner of the unused capacity and an owner of the unused capacity requests use of the capacity at the same time, the system stops the use of the capacity by the non-owner, wherein the owner of the capacity is one that pays for use of the capacity.

24. The system of claim 20, wherein the servers split each of the source streams into a plurality of sub-streams to be sent to the plurality of clients, further comprising:
a plurality of routers delivering the sub-streams from the servers to the clients at transmission rates proportional to respective unused capacities of the routers.

25. The system of claim 24, wherein the transmission rates of the sub-streams are determined to be
$$\frac{{c}_{i} \cdot s}{{\sum }_{{∀}_{i}} {c}_{i}} ,$$
wherein s indicates the rate of the source stream and Ci is the unused bandwidth from an i-th router to the clients, for the source stream.

26. The system of claim 24, wherein the routers include multicast routers for duplicating the sub-streams to be sent to the clients.

27. The system of claim 24, wherein the routers include unicast routers for forwarding the sub-streams to the clients.

28. The system of claim 24, wherein the sub-streams are delivered to the routers over independent paths in the communication network, wherein the paths or sub-paths do not cross each other in the space-time trajectories of the paths or sub-paths.

29. The system of claim 20, further comprising a plurality of control devices for performing an admission control to determine whether a connection requested by one of the clients is established.

30. The system of claim 29, wherein the plurality of control devices further performs a resource allocation based on the unused capacities.
